(19) United States
(12) Patent Application Publication
(10) Pub. No.: US 2026/0065187 A1
(43) Pub. Date: Mar. 5, 2026

(54) SYSTEM AND METHOD FOR PLANNING FRONT-OF-STORE LAYOUT

(71) Applicant: NCR VOYIX CORPORATION, ATLANTA, GA (US)

(72) Inventor: Itamar David Laserson, Givat Shmuel (IL)

(21) Appl. No.: 18/821,437

(22) Filed: Aug. 30, 2024

(51) Int. Cl. G06Q 10/0631; G06Q 10/0637; G06Q 10/067

(52) U.S. Cl. CPC G06Q 10/06315; G06Q 10/06375; G06Q 10/067

(57) ABSTRACT

In a system and method for providing a front-of-store layout recommendation for a retail store location having a plurality of terminals, historical transactions data for the retail store location is received and stored at a remote server which identifies, for each transaction, whether the transaction was at a point of sale (POS) terminal or a self-checkout (SCO) terminal. One or more training sets of data, based on the received and stored historical transactions data, is used to generate a machine learning model that provides a recommendation of a number of terminals to be configured as POS terminals and a number of terminals to be configured as SCO terminals. Current transactions data and parameter information is provided to the machine learning model to generate a current front-of-store layout recommendation. The current front-of-store layout recommendation is provided to a user via a user interface.

### FIELD

This disclosure relates generally to a system and method for planning front-of-store layout, and more particularly to a system and method in which a machine learning model is generated and used for planning front-of-store layout.

### BACKGROUND

Front-of-store layout planning is an important task for a retail store manager. Modern retail stores combine point of sale (POS) terminal lanes, in which a cashier supervises the checkout process, and self-checkout (SCO) terminal lanes, in which the customer performs checkout on their own. The front-of-store layout defines how many POS terminal lanes and how many SCO lanes are deployed at the retail store and their relative physical location within the retail store. Labor capacity planning is another important task for the retail store manager, determining the staff needed to support the customer traffic at the store at any given time-of-day. Labor capacity planning is impacted by the front-of-store layout, because the staffing is limited by the number of POS terminal lanes available and the number and location of SCO lanes available. For example, if the layout at a retail store has only five POS terminal lanes, then at most five cashiers can be scheduled to work at one time. If the layout of the retail store location has eight SCO terminal lanes at a single location within the retail store, only a single SCO attendant is necessary, but if the eight SCO terminal lanes are split in two (or more) different areas within the retail store, then two (or more) SCO attendants are needed at all times. It is important to optimize both the front-of-store layout and labor capacity planning in order to reduce labor costs while at the same time ensuring a positive checkout experience for the customer by, for example, minimizing checkout wait times.

In the past, labor capacity planning only focused on labor requirements because the front-of-store layout (in terms of POS terminal lanes versus SCO terminal lanes) was fixed as exchanging a POS terminal lane for an SCO terminal lane was a labor-intensive process and thus not done frequently. However, modern hybrid terminal products are now available that can shift from an SCO lane to a POS lane (or vice versa) within minutes. This allows retail stores to respond much quicker to changes of traffic within the store by converting lanes between SCO and POS. However, because hybrid terminal products are so new to the industry, a retail store manager is currently only able to apply intuition to determine when to switch a lane from SCO to POS, or vice versa, to reduce labor costs while maintaining customer satisfaction by way of minimizing checkout wait times. This reliance on intuition likely leads to suboptimal results and missed opportunities to reduce labor costs.

Accordingly, there is a need for a better way of planning front-of-store layout.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a system according to an aspect of the current disclosure;

FIG. 2 is a schematic block diagram of an example computing system for use in the system of the current disclosure;

FIG. 3 is a block diagram of a retail location server for use in the system of the current disclosure;

FIG. 4 is a block diagram of a remote server for use in the system of the current disclosure; and

FIG. 5 is a flowchart of a method of operation of the system of the current disclosure.

### DETAILED DESCRIPTION

In the present disclosure, like reference numbers refer to like elements throughout the drawings, which illustrate various exemplary embodiments of the present disclosure.

The present disclosure describes a system and method which provides an improved way of planning front-of-store layout. The system and method uses a machine learning model which receives customer traffic data information based on the current retail store layout of SCO terminals and POS terminals, forecasts a volume of sales traffic and type of sales traffic (SCO versus POS) expected in the retail store in a defined upcoming period, and provides a recommendation, in near real-time, on how to configure the front-of store layout (in terms of numbers of SCO terminals versus POS terminals) for that defined upcoming period.

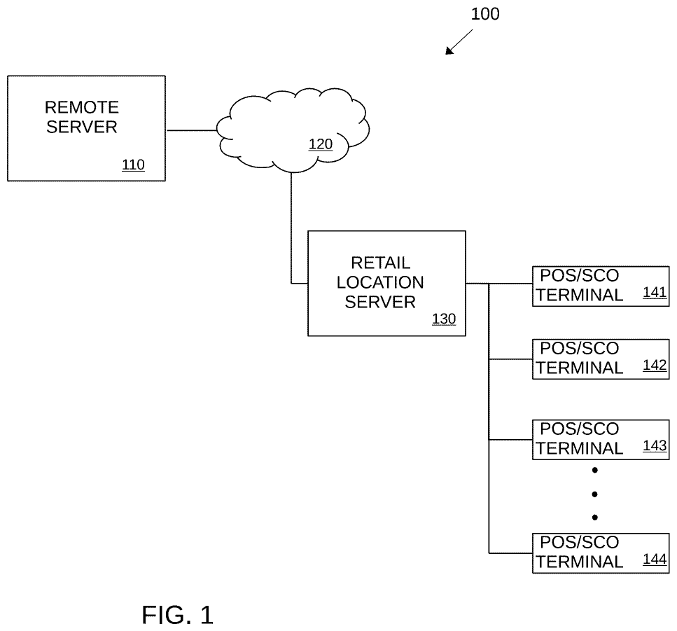

Referring now to FIG. 1, a system 100 for front-of-store layout planning for a retail location includes a remote server 110 and a retail location server 130 at a retailer location coupled via a network 120. The retail location server 130 is coupled to a plurality of terminals 141 to 145 which can be configured as either a point-of-sale (POS) terminal that is manned by a single attendant or a self-checkout (SCO) terminal that is part of a group of SCO terminals that are manned by an attendant.

Referring now to FIG. 3, the retail location server 130 includes a memory 132 that has a non-transitory computer-readable storage medium portion 133 that includes a store manager module 134, a front-of-store planning interface 136, and a reporting system module 138, the operation of which is explained below.

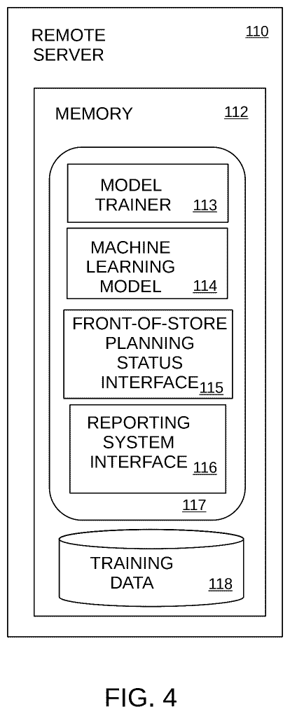

Referring now to FIG. 4, the remote server 110 includes a memory 112 that has a non-transitory computer-readable storage medium portion 117 that includes a model trainer module 113, a machine learning model 114, a front-of-store planning status interface 115, and a reporting system interface 116. Remote server 110 also includes a memory 118 for storing training data, i.e., the data that is used to train the machine learning model 114.

The store manager module 134 in the retail location server 130 is coupled to coordinate the operation of all of the associated POS/SCO terminals 141 to 144 at that retail location. Four POS/SCO terminals are shown in FIG. 1, but this number can vary from two to N, depending on the size of the particular retail location. Each POS/SCO terminal is installed at a particular physical location (i.e., a dedicated lane) at that retail location.

The front-of-store planning status interface 136 in the retail location server 130 communicates with the front-of-store planning status interface 115 in the remote server 110 to provide parameter information (e.g., a definition of the period of time for an upcoming front-of-store layout recommendation and/or how often the machine learning model 113 should run to process the latest information) and to receive the latest output from machine learning model 113 identifying a currently recommended front-of-store layout. The recommended front-of-store layout includes, in an embodiment, a breakdown of how many terminals, out of all the terminals at the retail location, should be set up as a POS terminal (i.e., attended) and how many terminals, out of all the terminals at the retail location, should be set up as an SCO terminal (i.e., self-checkout with only one attendant for a group of SCO terminals). Further, the recommended front-of-store layout may also include a designation of a lane location (the physical location within the retail location) for each designated POS terminal and for each designated SCO terminals. In some cases, not all terminals may be designated as active at all times, e.g., during low traffic periods in early morning or late evening hours.

The reporting system module 138 in the retail location server 130 receives information for each customer transaction from all of the active POS/SCO terminals 141 to 144 and forwards such information to the reporting system interface 116 in the remote server 110. This information may include, for example, an itemization of the goods (to determine if the transaction involves weighted goods which are more likely to require an attended lane), a quantity of goods (lower quantities are more likely to be at a SCO terminal while larger quantities are more likely to be at a POS terminal), the type of terminal (POS versus SCO), the payment method (cash versus credit/debit, with cash payments more likely at a POS terminal), time of day, day, and expected shrinkage at that retail location at that time of day and day.

The model trainer module 113 in the remote server 110 trains the machine learning model 114 based on the data stored in the training data memory 118, as discussed below. Model trainer module 113 may generate one set or more than one subsets of training data from the training data memory 118 for use in both creating and evaluating the machine learning model 114. Furthermore, the machine learning model 114 continuously updates as new data is received so as to adapt to new patterns and trends without requiring a complete retraining.

The front-of-store planning status interface 115 in the remote server 110 interacts with the front-of-store planning interface 136 in the retail location server 130, as discussed herein, to receive parameter information provided by a user, to forward such parameter information to the machine learning model 114, and to receive output information and forward such output information (i.e., a currently recommended layout) back to the front-of-store planning interface 136. The parameter information may include, for example, a definition of the period of time for an upcoming front-of-store layout recommendation and/or a definition of how often the machine learning model 114 processes current transaction data to provide the front-of-store layout recommendation.

The reporting system interface 116 in the remote server 110 receives information from the reporting system module 138 at the retail location server 130, stores such data in the training data memory 118, and provides such data to the machine learning model 114.

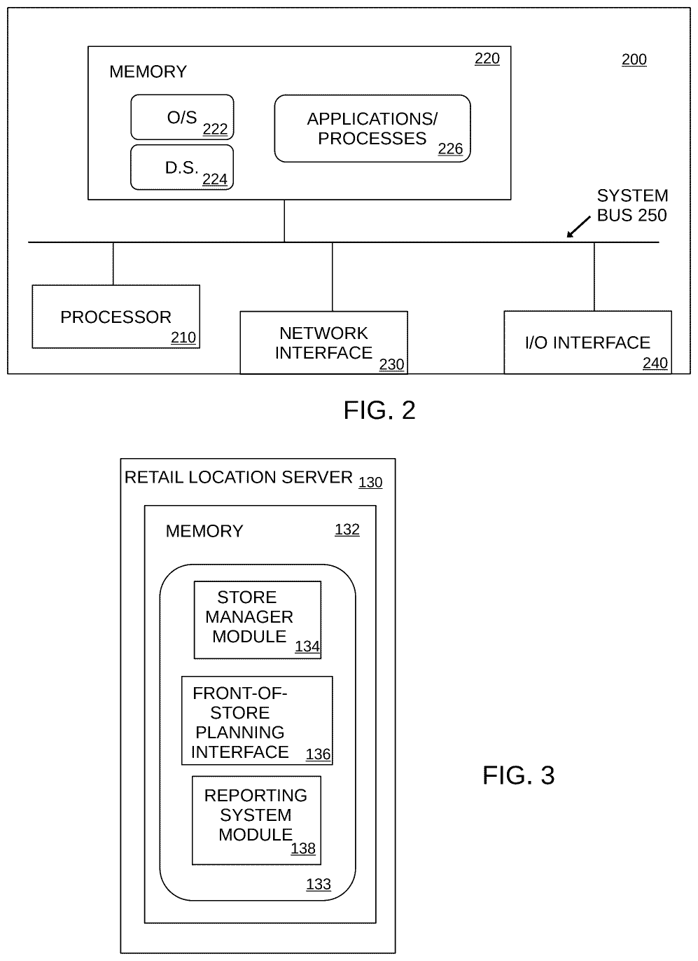

FIG. 2 is a schematic block diagram of an example computing system or device 200 that may be used with one or more embodiments described herein, e.g., as the servers 110, 130 shown in FIG. 1. Device 200 may include a processor 210 (which may be a single processor or a plurality of linked processors), a memory 220, one or more network interfaces 230 (e.g., wired, wireless, etc.), and one or more input/output (I/O) interfaces 240, which may be interconnected by a system bus 250. The network interface(s) 230 and the I/O interface(s) 240 are referred to in the singular hereinafter for ease of explanation. The network interface 230 contains the necessary circuitry for communicating data over links coupled to the network 120. The network interface 230 may be configured to transmit and/or receive data using a variety of different communication protocols. Note, further, that configuration of device 200 shown in FIG. 2 is merely illustrative, and device 200 may have multiple types of network connections via multiple network interfaces 230, e.g., wireless and wired/physical connections.

The memory 220 may include a plurality of storage locations that are addressable by the processor 210 and the network interface 230 for storing software programs and data structures associated with the embodiments described herein. The parts of memory 220 that store software programs, including any operating system, may be a non-transitory computer-readable storage medium. The processor 210 may comprise hardware elements or hardware logic adapted to execute software programs and manipulate the data structures 224. An operating system 222, portions of which are typically resident in memory 220 and executed by the processor 210, functionally organizes the device 200 by, among other things, invoking operations in support of software processes and/or services executing on the device 200. These software processes and/or services may include one or more applications/processes 226.

The I/O interface 240 may not be present in all embodiments (e.g., when the device 200 is a cloud-based server), but when present, typically includes a user interface (UI) that has an input device, such as an alpha-numeric keypad (e.g., a keyboard) for inputting alpha-numeric and other information, a pointing device (e.g., a mouse, a trackball, stylus, or cursor direction keys), a touchscreen or other type of display, a microphone, and/or a camera.

The model trainer module 113 trains the machine learning model 114 to forecast a volume of store traffic and type of store traffic (by day and time of day) and based thereon to provide a currently recommended front-of-store layout for a period of time provided as an input, including how to configure the POS/SCO terminals to provide an appropriate blend of POS terminals and SCO terminals (i.e., the number of terminals to be set as POS and the number of terminals to be set as SCO). The recommended front-of-store layout preferably also includes an identification of the location (lane) for each of the terminals designated as POS and terminals designated as SCO within the retail store. The model trainer module 113 initially uses the training data (or subsets thereof) stored in the training data memory 118 at the remote server 110 to generate the machine learning model 114. This data may include, for example, historical transaction information for the retail store. In one embodiment, this data may include, for each transaction, an itemization of the goods (to determine if the transaction involves weighted goods which are more likely to require an attended lane), a quantity of goods (lower quantities are more likely to be at a SCO terminal while larger quantities are more likely to be at a POS terminal), the type of terminal (POS versus SCO), the location of the terminal (e.g., the lane), the payment method (cash versus credit/debit, with cash payments more likely at a POS terminal), time of day, day, and expected shrinkage at that retail location at that time of day and day.

The machine learning model 114 continually processes the received data to provide, at regular intervals, the front-of store layout recommendation as defined above. The regular interval may be set by a user, e.g., the retail store manager, and is preferably set to a short interval (e.g., several minutes) to ensure responsiveness to changing needs in order to provide optimal customer satisfaction. The front-of store layout recommendation may provide a definition of an overall layout (e.g., five lanes set to POS and five lanes set to SCO for an upcoming defined period) or may be presented in the form of changes required for the next predefined period (e.g., change lanes 1 and 2 from POS to SCO for the upcoming defined period).

Upon receipt of each new recommendation, the front-of-store planning status interface 136 will provide a notice to a user, e.g., the store manager, of the current recommendation. The notice may be provided via a display associated with the retail location server 130, or via an alert provided to an application running on a mobile device of the store manager. In this manner, the system and method of the present disclosure operates in near real-time to produce recommendations on front-of-store layout changes in order to quickly adapt to changing store traffic conditions. Because the machine learning model 114 automatically learns from experience, the system and method of the present disclosure is adaptive and remains relevant despite changing traffic conditions that may occur over time as sales and shopping patterns change.

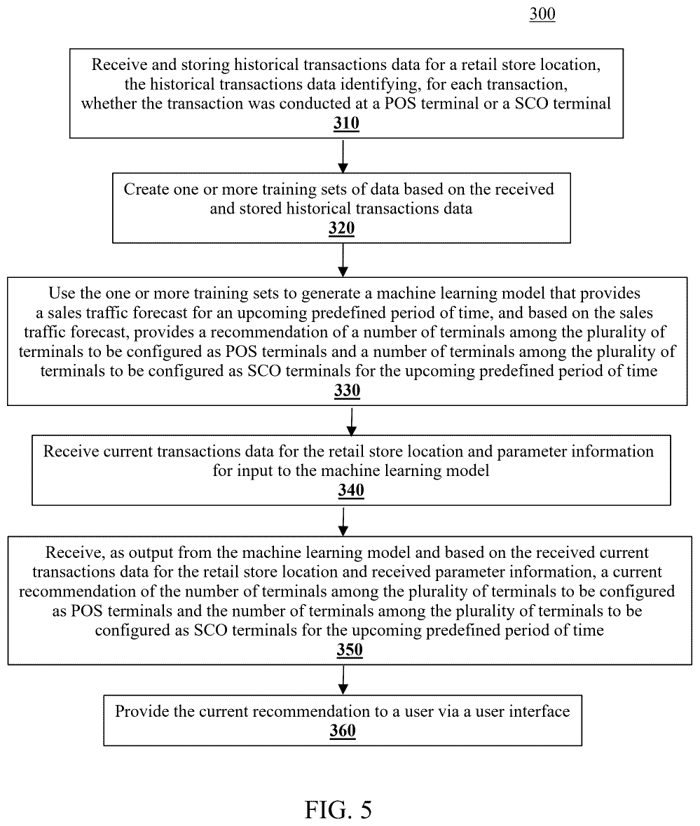

FIG. 5 is a flowchart of the method 300 of the present disclosure. As shown in FIG. 5, method 300 may include receiving and storing historical transactions data for a retail store location, the historical transactions data identifying, for each transaction, whether the transaction was conducted at a POS terminal or an SCO terminal (block 310). For example, the remote server 110 may receive and store historical transactions data from the retail location server 130. This historical transactions data identifies, for each transaction, whether the transaction was conducted at a POS terminal or an SCO terminal, as described above.

As also shown in FIG. 5, method 300 may include creating one or more training sets of data based on the received and stored historical transactions data (block 320). For example, model trainer 113 may create one or more training sets of data based on the received and stored historical transactions data, as described above.

As further shown in FIG. 5, method 300 may include using the one or more training sets to generate a machine learning model 114 that provides a sales traffic forecast for an upcoming predefined period of time, and based on the sales traffic forecast, provides a recommendation of a number of terminals among the plurality of terminals to be configured as POS terminals and a number of terminals among the plurality of terminals to be configured as SCO terminals for the upcoming predefined period of time (block 330). For example, model trainer 113 may use the one or more training sets to generate a machine learning model 114 that provides a sales traffic forecast for an upcoming predefined period of time, and based on the sales traffic forecast, provides a recommendation of a number of terminals among the plurality of terminals to be configured as POS terminals and a number of terminals among the plurality of terminals to be configured as SCO terminals for the upcoming predefined period of time, as described above.

As also shown in FIG. 5, method 300 may include receiving current transactions data for the retail store location and parameter information for input to the machine learning model (block 340). For example, reporting system interface 116 may receive current transactions data for the retail store location and front-of-store planning status interface 115 may receive parameter information for input to the machine learning model, as described above.

As further shown in FIG. 5, method 300 may include receiving, as output from the machine learning model 114 and based on the received current transactions data for the retail store location and received parameter information, a current recommendation of the number of terminals among the plurality of terminals to be configured as POS terminals and the number of terminals among the plurality of terminals to be configured as SCO terminals for the upcoming predefined period of time (block 350). For example, front-of-store planning interface 136 may receive, as output from the machine learning model 114 and based on the received current transactions data for the retail store location and received parameter information, a current recommendation of the number of terminals among the plurality of terminals to be configured as POS terminals and the number of terminals among the plurality of terminals to be configured as SCO terminals for the upcoming predefined period of time, as described above.

As also shown in FIG. 5, method 300 may include providing the current recommendation to a user via a user interface (block 360). For example, front-of-store planning interface 136 may provide the current recommendation to a user via a user interface, as described above.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

1. A method for providing a front-of-store layout recommendation for a retail store location having a plurality of terminals that are configurable as either a point of sale (POS) terminal or a self-checkout (SCO) terminal, comprising:
receiving and storing historical transactions data for the retail store location, the historical transactions data identifying, for each transaction, whether the transaction was conducted at a POS terminal or an SCO terminal;
creating one or more training sets of data based on the received and stored historical transactions data;
using the one or more training sets to train a machine learning model to provide a sales traffic forecast, and based on the sales traffic forecast, to provide a front-of-store layout recommendation of a number of terminals among the plurality of terminals to be configured as POS terminals and a number of terminals among the plurality of terminals to be configured as SCO terminals;
receiving current transactions data for the retail store location and parameter information for input to the machine learning model;
receiving, as output from the machine learning model and based on the received current transactions data for the retail store location and received parameter information, a current front-of-store layout recommendation comprising the number of terminals among the plurality of terminals to be configured as POS terminals and the number of terminals among the plurality of terminals to be configured as SCO terminals; and
providing the current front-of-store layout recommendation to a user via a user interface.

2. The method of claim 1, comprising using the one or more training sets to train the machine learning model to provide, based on the sales traffic forecast, an identification of a physical location in the retail store location for each of the terminals designated as POS and a physical location in the retail store location for each of the terminals designated as SCO.

3. The method of claim 2, wherein the current front-of-store layout recommendation comprises the identification of the physical location in the retail store location for each of the terminals designated as POS and the physical location in the retail store location for each of the terminals designated as SCO.

4. The method of claim 1, comprising updating the machine learning model as current transaction data is received.

5. The method of claim 1, wherein the historical transaction data comprises, for each transaction, at least one of an itemization of the goods for the transaction, a quantity of goods for the transaction, a type of terminal for the transaction, a physical location of a terminal associated with the transaction, a payment method for the transaction, a time of day for the transaction, and a day for the transaction.

6. The method of claim 1, wherein the historical transaction data comprises, for each transaction, an itemization of the goods for the transaction, a quantity of goods for the transaction, a type of terminal for the transaction, a physical location of a terminal associated with the transaction, a payment method for the transaction, a time of day for the transaction, and a day for the transaction.

7. The method of claim 1, wherein the current transaction data comprises, for each current transaction, at least one of an itemization of the goods for the transaction, a quantity of goods for the transaction, a type of terminal for the transaction, a physical location of a terminal associated with the transaction, a payment method for the transaction, a time of day for the transaction, and a day for the transaction.

8. The method of claim 1, wherein the current transaction data comprises, for each current transaction an itemization of the goods for the transaction, a quantity of goods for the transaction, a type of terminal for the transaction, a physical location of a terminal associated with the transaction, a payment method for the transaction, a time of day for the transaction, and a day for the transaction.

9. The method of claim 1, wherein the parameter information comprises a definition of a period of time for the current front-of-store layout recommendation.

10. The method of claim 1, wherein the parameter information comprises a definition of how often the machine learning model provides the current front-of-store layout recommendation.

11. A system for providing a front-of-store layout recommendation for a retail store location having a plurality of terminals that are configurable as either a point of sale (POS) terminal or a self-checkout (SCO) terminal, comprising:
a retail location server comprising at least one processor and an associated non-transitory computer-readable storage medium, the non-transitory computer-readable storage medium associated with the retail location server comprising executable instructions;
a remote server comprising at least one processor and an associated non-transitory computer-readable storage medium, the remote server coupled to the retail location server;
the non-transitory computer-readable storage medium associated with the remote server comprising executable instructions; and
the executable instructions when executed by at least one processor in the remote server cause the at least one processor to perform operations, comprising:
receiving and storing historical transactions data for the retail store location, the historical transactions data identifying, for each transaction, whether the transaction was conducted at a POS terminal or an SCO terminal;
creating one or more training sets of data based on the received and stored historical transactions data;
using the one or more training sets to generate a machine learning model that provides a sales traffic forecast, and based on the sales traffic forecast, provides a front-of-store layout recommendation of a number of terminals among the plurality of terminals to be configured as POS terminals and a number of terminals among the plurality of terminals to be configured as SCO terminals;
receiving current transactions data for the retail store location and parameter information for input to the machine learning model;
receiving, as output from the machine learning model and based on the received current transactions data for the retail store location and received parameter information, a current front-of-store layout recommendation comprising the number of terminals among the plurality of terminals to be configured as POS terminals and the number of terminals among the plurality of terminals to be configured as SCO terminals; and
providing the current recommendation to the retail location server; and
wherein the executable instructions in the retail location server, when executed by at least one processor in the retail location server cause the at least one processor to perform operations comprising providing the current front-of-store layout recommendation to a user via a user interface.

12. The system of claim 11, wherein the executable instructions stored in the non-transitory computer-readable storage medium associated with the remote server, when executed by at least one processor in the remote server, cause the at least one processor to perform operations comprising using the one or more training sets to train the machine learning model to provide, based on the sales traffic forecast, an identification of a physical location in the retail store location for each of the terminals designated as POS and a physical location in the retail store location for each of the terminals designated as SCO.

13. The system of claim 12, wherein the current front-of-store layout recommendation comprises the identification of the physical location in the retail store location for each of the terminals designated as POS and the physical location in the retail store location for each of the terminals designated as SCO.

14. The system of claim 11, wherein the executable instructions stored in the non-transitory computer-readable storage medium associated with the remote server, when executed by at least one processor in the remote server, cause the at least one processor to perform operations comprising updating the machine learning model as current transaction data is received.

15. The system of claim 11, wherein the historical transaction data comprises, for each transaction, at least one of an itemization of the goods for the transaction, a quantity of goods for the transaction, a type of terminal for the transaction, a physical location of a terminal associated with the transaction, a payment method for the transaction, a time of day for the transaction, and a day for the transaction.

16. The system of claim 11, wherein the historical transaction data comprises, for each transaction, an itemization of the goods for the transaction, a quantity of goods for the transaction, a type of terminal for the transaction, a physical location of a terminal associated with the transaction, a payment method for the transaction, a time of day for the transaction, and a day for the transaction.

17. The system of claim 11, wherein the current transaction data comprises, for each current transaction, at least one of an itemization of the goods for the transaction, a quantity of goods for the transaction, a type of terminal for the transaction, a physical location of a terminal associated with the transaction, a payment method for the transaction, a time of day for the transaction, and a day for the transaction.

18. The system of claim 11, wherein the current transaction data comprises, for each current transaction an itemization of the goods for the transaction, a quantity of goods for the transaction, a type of terminal for the transaction, a physical location of a terminal associated with the transaction, a payment method for the transaction, a time of day for the transaction, and a day for the transaction.

19. The system of claim 11, wherein the parameter information comprises a definition of a period of time for the current front-of-store layout recommendation.

20. The system of claim 11, wherein the parameter information comprises a definition of how often the machine learning model provides the current front-of-store layout recommendation.
